(19) United States
(12) Patent Application Publication
(10) Pub. No.: US 2009/0258620 A1
(43) Pub. Date: Oct. 15, 2009

(54) Terminal and Operating Method Thereof

(76) Inventor: Jae Kil Jung, Gwangju (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/305,586

(22) PCT Filed: Dec. 24, 2007
(86) PCT No.: PCT/KR07/06804

§ 371 Date: Dec. 18, 2008

(30) Foreign Application Priority Data
Dec. 29, 2006 (KR) 10-2006-0138185

(51) Int. Cl. H04B 1/18; H04B 1/68

(52) U.S. Cl. 455/200.1; 455/204

(57) ABSTRACT

A terminal is provided. The terminal comprises a tuner converting a received high-frequency signal, a VSB (vestigial side band) demodulator demodulating the output signal of the tuner into a VSB signal, a DMB (digital multimedia broadcasting) demodulator demodulating the output signal of the tuner into a DMB signal, a decoder decoding the demodulated VSB signal or the demodulated DMB signal into an image signal, and a controller controlling at least one of the tuner, the VSB demodulator, the DMB demodulator, and the decoder.

### TECHNICAL FIELD

The embodiment relates to a terminal and an operating method thereof.

### BACKGROUND ART

A DMB (digital multimedia broadcasting) is a new conceptual mobile multimedia broadcasting service that integrates broadcast and communication. While moving or standing, a mobile terminal, a PDA (personal digital assistant), and a vehicle-mounted terminal can receive high-quality data and images through a mounted DMB receiving module.

According to transmission schemes, digital-broadcasting systems are classified into an American ATSC (advanced television systems committee) system using VSB (vestigial side band) modulation technology, and a European DVB-T (digital video broadcasting-terrestrial) system using OFDM (orthogonal frequency division multiplexing) modulation technology.

The VSB based on the NTSC (national television system committee) system is convenient and economical in embodying a transmitter and a receiver, and allows a higher data transmission rate in the same amount of bandwidth. However, the VSB is inadequate for mobile reception because it may not support mobile reception in connection with a single frequency network and is susceptible to multipath interference.

In Korea and United state, a user watches digital broadcasting using a television, a set-top box, and a personal computer and the like that are capable of receiving a VSB channel. While moving, a user watches digital broadcasting using a mobile terminal that is capable of receiving a DMB channel.

Since the VSB based on the NTSC system is a kind of a SCM (single carrier modulation), it is excellent in transmission of high-quality images (HD image). However, images transmitted using the VSB are damaged during transmission in a tall building region or a mountain region.

On the other hand, a DMB is apt for mobile reception, so that a user can watch an undamaged image while moving. However, the DMB provides a lower image quality (SD image) than the VSB.

### DISCLOSURE OF INVENTION

### Technical Problem

Embodiments provide a terminal for adaptively selecting a VSB channel or a DMB channel according to receiving environment and a method for operating the terminal.

### Technical Solution

An embodiment provides a terminal comprising: a tuner converting a received high-frequency signal; a vestigial side band demodulator demodulating the output signal of the tuner into a vestigial side band signal; a digital multimedia broadcasting demodulator demodulating the output signal of the tuner into a digital multimedia broadcasting signal; a decoder decoding the demodulated vestigial side band signal or the demodulated digital multimedia broadcasting signal into an image signal; and a controller controlling at least one of the tuner, the vestigial side band demodulator, the digital multimedia broadcasting demodulator, and the decoder.

An embodiment provides a method for operating a terminal. The method comprising: receiving a high-frequency signal received through a vestigial side band channel or a digital multimedia broadcasting channel using one tuner; demodulating an output signal of the tuner into a vestigial side band signal or a digital multimedia broadcasting signal according to characteristic of the output signal; and decoding the demodulated vestigial side band signal or the demodulated digital multimedia broadcasting signal into an image signal.

An embodiment provides a method for operating a terminal. The method comprising: receiving a high-frequency signal through a vestigial side band channel using one tuner; demodulating the output signal of the tuner into a vestigial side band signal; and determining a reception error rate on the demodulated vestigial side band channel, and controlling the tuner to select and receive a digital multimedia broadcasting channel when the reception error rate is larger than a preset error rate.

### ADVANTAGEOUS EFFECTS

According to the terminal and the operating method thereof, the terminal may adaptively select the VSB channel or the DMB channel in consideration of receiving environment.

### BRIEF DESCRIPTION OF THE DRAWINGS

FIG. 1 is a block diagram of a terminal according to one embodiment.

FIG. 2 is a flowchart of a method for operating a terminal according to one embodiment.

FIG. 3 is a flowchart of a method for operating a terminal according to another embodiment.

### MODE FOR THE INVENTION

Reference will now be made in detail to the embodiments of the present disclosure, examples of which are illustrated in the accompanying drawings.

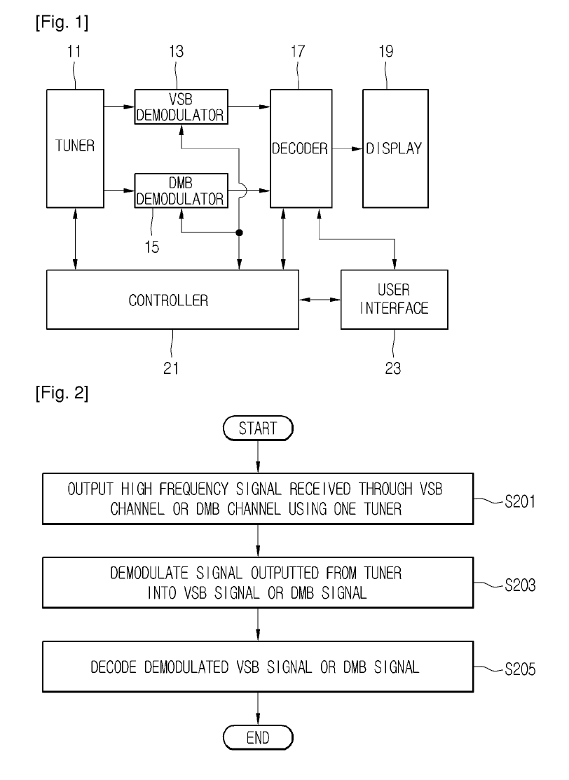

FIG. 1 is a block diagram of a terminal according to one embodiment.

The terminal comprises a tuner 11, a VSB demodulator 13, a DMB demodulator 15, a decoder 17, a display 19, a controller 21, and a user interface 23.

The tuner 11 converts a received high-frequency signal through an antenna. The tuner 11 may select a VSB channel or a DMB channel. The tuner 11 converts a high-frequency band signal received through the VSB channel into an intermediate frequency band signal of, e.g., 44 Mhz. Also, the tuner 11 converts a high-frequency band signal received through the DMB channel into an intermediate frequency band signal of, e.g., 44 Mhz. As described above, the converted frequency bands are the same, so that the tuner 11 may select a VSB channel or a DMB channel using one circuit. The tuner 11 may comprise an oscillator and a mixer. The tuner 11 selects a channel using a reference frequency provided from the oscillator.

The VSB demodulator 13 demodulates the intermediate frequency band signal of the tuner 11 into a VSB signal. Specifically, the VSB demodulator 13 may demodulate the 44 Mhz intermediate frequency signal of the tuner 11 into a VSB signal with a bandwidth of 6 Mhz for one channel. The demodulated VSB signal may be MPEG data.

The DMB demodulator 15 demodulates the intermediate frequency band signal of the tuner 11 into a DMB signal. Specifically, the DMB demodulator 15 may demodulate the 44 Mhz intermediate frequency signal of the tuner 11 into a DMB signal with a bandwidth of 2 Mhz for one channel. The demodulated DMB signal may be MPEG data.

The decoder 17 decodes the VSB or DMB signal of the VSB demodulator 13 or the DMB demodulator 15 into an image signal. The display 19 displays an image decoded by the decoder 17. The controller 21 controls the tuner 11, the VSB demodulator 13, the DMB demodulator 15, and the decoder 17.

The user interface 23 may receive commands from a user, and provide information on a channel through which a broadcasting program is being currently received. The tuner 11 may select a VSB channel or a DMB channel according to a user command inputted through the user interface 23. In this case, the tuner 11 may convert a signal received through a VSB channel or a DMB channel under the control of the controller 21.

The user interface 23 may comprise, e.g., a touch panel. Thus, a user may easily select an appropriate channel by pressing a corresponding channel on the touch panel based on channel information displayed on the touch panel of the user interface 23.

The user interface 23 may be integral to the display 19. And the user interface 23 may be separately provided with the display 19.

The VSB demodulator 13 and the DMB demodulator 15 record reception errors that occur in demodulation of broadcasting signals. When the reception errors occur, temporary loss of an image being displayed on the display 19 may arise and the quality of the image may be deteriorated. The reception error may be detected as packet error.

According to one embodiment, the controller 21 determines a reception error rate of the VSB channel demodulated by the VSB demodulator 13. Then, the controller 21 controls the tuner 11 to select a DMB channel when the reception error rate is greater than a preset error rate.

When 65,536 packets are needed to display an image frame and 10 packet errors are happened, the user may recognize a deterioration of displayed image. Therefore the controller 21 may control the tuner 11 to select a DMB channel when 10 packet errors are detected. And the controller 21 may control the tuner 11 to select a DMB channel when the reception error rate is greater than 0.015%.

At this time, the tuner 11 may select a DMB channel that provides the same content as received through the VSB channel. When the DMB channel providing the same content dose not exist, the controller 21 may provide information on receptible DMB channels to a user, and request the user to select one DMB channel among the receptible DMB channels.

According to the above described embodiment, while a terminal is receiving a high-quality image signal through a VSB channel, when a reception rate of the VSB channel decreases due to movement of the terminal and the like, the terminal may receive a DMB channel. A reception rate of a DMB channel is high even while the terminal is moving, so that a user can watch broadcasting without packet errors.

FIG. 2 is a flowchart of a method for operating a terminal according to one embodiment.

According to the method, as illustrated in FIGS. 1 and 2, in operation 201, one tuner 11 receives a high-frequency signal through a VSB channel or a DMB channel.

In operation 203, an output signal of the tuner 11 is demodulated into a VSB signal or a DMB signal according to characteristic of the output signal. When a VSB channel is received, the VSB demodulator 13 demodulates the output signal of the tuner 11 into a VSB signal. Likewise, when a DMB channel is received, the DMB demodulator 15 demodulates the output signal of the tuner 11 into a DMB signal.

In operation 205, the decoder 17 decodes the demodulated VSB signal or the demodulated DMB signal into an image signal. The display 19 may display the decoded image signal.

According to one embodiment, the user interface 23 may display information on a channel through which a broadcasting program is being currently received. At this time, the user interface 23 may comprise a touch panel. Accordingly, a user may easily select an appropriate channel by pressing a corresponding channel on the touch panel according to channel information displayed on the touch panel of the user interface 23.

The tuner 11 may select a VSB channel or a DMB channel according to a user command inputted through the user interface 23. At this time, the tuner 11 may convert a signal received through the VSB channel or the DMB channel under the control of the controller 21.

According to one embodiment, the controller 21 determines a reception error rate of the VSB channel demodulated by the VSB demodulator 13. Then, the controller 21 controls the tuner 11 to select a DMB channel when the reception error rate is greater than a preset error rate.

When 65,536 packets are needed to display an image frame and 10 packet errors are happened, the user may recognize a deterioration of displayed image. Therefore the controller 21 may control the tuner 11 to select a DMB channel when 10 packet errors are detected. And the controller 21 may control the tuner 11 to select a DMB channel when the reception error rate is greater than 0.015%.

At this time, the tuner 11 may select a DMB channel that provides the same content as received through the VSB channel. When the DMB channel providing the same content dose not exist, the controller 21 may provide information on receptible DMB channels to a user, and request the user to select one DMB channel among the receptible DMB channels.

According to the above described embodiment, while a terminal is receiving a high-quality image signal through a VSB channel, when a reception rate of the VSB channel decreases due to movement of the terminal and the like, the terminal may receive a DMB channel. A reception rate of a DMB channel is high even while the terminal is moving, so that a user can watch broadcasting without packet errors.

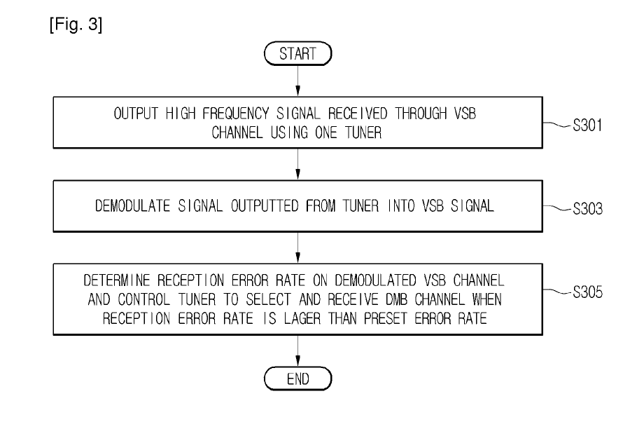

FIG. 3 is a flowchart of a method for operating a terminal according to another embodiment.

According to the method, as illustrated in FIGS. 1 and 3, in operation 301, a high-frequency signal through a VSB channel is received through one tuner 11.

In operation 303, the VSB demodulator 13 demodulates an output signal of the tuner 11 into a VSB signal. At this time, the VSB demodulator 13 records reception errors that occur in the demodulation process. When the reception errors occur, temporary loss of the image being displayed on the display 19 may arise and the quality of the image may be deteriorated. The reception error may be detected as packet error.

In operation 305, the controller 21 determines a reception error rate of the demodulated VSB channel, and controls the tuner 11 to select a DMB channel when the reception error rate is greater than a preset error rate.

When 65,536 packets are needed to display an image frame and 10 packet errors are happened, the user may recognize a deterioration of displayed image. Therefore the controller 21 may control the tuner 11 to select a DMB channel when 10 packet errors are detected. And the controller 21 may control the tuner 11 to select a DMB channel when the reception error rate is greater than 0.015%.

At this time, the tuner 11 may select a DMB channel that provides the same content as received through the VSB channel. When the DMB channel providing the same content dose not exist, the controller 21 may provide information on receptible DMB channels to a user, and request the user to select one DMB channel among the receptible DMB channels.

According to the above described embodiment, while a terminal is receiving a high-quality image signal through a VSB channel, when a reception rate of the VSB channel decreases due to movement of the terminal and the like, the terminal may receive a DMB channel. A reception rate of a DMB channel is high even while the terminal is moving, so that a user can watch broadcasting without packet errors.

Any reference in this specification to “one embodiment”, “an embodiment”, “example embodiment”, etc., means that a particular feature, structure, or characteristic described in connection with the embodiment is comprised in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### INDUSTRIAL APPLICABILITY

According to the terminal and the operating method thereof, the terminal may adaptively select a VSB channel or a DMB channel according to receiving environment.

1. A terminal comprising;
a tuner converting a received high-frequency signal;
a vestigial side band demodulator demodulating the output signal of the tuner into a vestigial side band signal;
a digital multimedia broadcasting demodulator demodulating the output signal of the tuner into a digital multimedia broadcasting signal;
a decoder decoding the demodulated vestigial side band signal or the demodulated digital multimedia broadcasting signal into an image signal; and
a controller controlling at least one of the tuner, the vestigial side band demodulator, the digital multimedia broadcasting demodulator, and the decoder.

2. The terminal according to claim 1, comprising a user interface receiving a command from a user.

3. The terminal according to claim 2, wherein the user interface displays information on a channel through which a broadcasting is being currently received.

4. The terminal according to claim 2, wherein the tuner selects a vestigial side band channel or a digital multimedia broadcasting channel according to a user command from the user interface.

5. The terminal according to claim 2, wherein the user interface comprises a touch panel.

6. The terminal according to claim 1, wherein the tuner converts a signal received through a vestigial side band channel or a digital multimedia broadcasting channel under the control of the controller.

7. The terminal according to claim 1, wherein the controller determines a reception error rate of a vestigial side band channel demodulated by the vestigial side band demodulator, and controls the tuner to select a digital multimedia broadcasting channel when the reception error rate is greater than a preset error rate.

8. The terminal according to claim 7, wherein the digital multimedia broadcasting channel selected by the tuner provides the same content as received through the vestigial side band channel.

9. The terminal according to claim 7, wherein the vestigial side band channel provides a higher quality image signal than the digital multimedia broadcasting channel.

10. A method for operating a terminal, the method comprising:
receiving a high-frequency signal received through a vestigial side band channel or a digital multimedia broadcasting channel using one tuner;
demodulating an output signal of the tuner into a vestigial side band signal or a digital multimedia broadcasting signal according to characteristic of the output signal; and
decoding the demodulated vestigial side band signal or the demodulated digital multimedia broadcasting signal into an image signal.

11. The method according to claim 10, comprising displaying, at a user interface, information on a channel through which a broadcasting is being received.

12. The method according to claim 11, comprising receiving a channel selected by a user through a touch panel, the touch panel being provided in the user interface.

13. The method according to claim 10, comprising, at the tuner, selectively receiving a vestigial side band channel or a digital multimedia broadcasting channel according to a user command inputted through a user interface.

14. The method according to claim 10, comprising:
determining a reception error rate of the demodulated vestigial side band channel; and
selecting and receiving a digital multimedia broadcasting channel when the reception error rate is greater than a preset error rate.

15. The method according to claim 14, wherein the selected digital multimedia broadcasting channel provides the same content as received through the vestigial side band channel.

16. The method according to claim 14, wherein the vestigial side band channel provides a higher quality image signal than the digital multimedia broadcasting channel.

17. A method for operating a terminal, the method comprising:
receiving a high-frequency signal through a vestigial side band channel using one tuner;
demodulating the output signal of the tuner into a vestigial side band signal; and
determining a reception error rate on the demodulated vestigial side band channel, and controlling the tuner to select and receive a digital multimedia broadcasting channel when the reception error rate is larger than a preset error rate.

18. The method according to claim 17, wherein the selected digital multimedia broadcasting channel provides the same content as received through the vestigial side band channel.

19. The method according to claim 17, wherein the vestigial side band channel provides a higher quality image signal than the digital multimedia broadcasting channel.
